(19) United States
(12) Patent Application Publication
(10) Pub. No.: US 2006/0213227 A1
(43) Pub. Date: Sep. 28, 2006

(54) Mold and a method for manufacturing the mold

(75) Inventor: Charles Leu, Fremont, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/322,064

(22) Filed: Dec. 29, 2005

(30) Foreign Application Priority Data
Mar. 23, 2005 (CN) 200510033808.0

(51) Int. Cl. C03B 7/14; C04B 35/64

(52) U.S. Cl. 65/374.15; 264/603

(57) ABSTRACT

The present invention provides a mold (10) for press molding articles, such as optical lenses. The mold includes a molding base (11) and a surface film (12). The molding base is made by a sintered composite of carbon nano fibers (13) and metal nano particles (14). The nano metal particles are selected from a group consisting of platinum, platinum-iridium alloy, rhenium and rhenium-iridium alloy. The surface film is formed on the molding base by a sputtering deposition method. A method for manufacturing the above-described mold is also provided. The mold has higher mechanical strength and better toughness than conventional molds that are made by metal alloy or metal ceramics.

### TECHNICAL FIELD

The present invention relates generally to a mold used for press molding articles such as optical lenses, and also to a method for manufacturing such mold.

### BACKGROUND

Recently, a desire has arisen for digital cameras and mobile phones with a digital camera with small-sized, lightweight and low cost, and therefore simplification of the lens system has been required. Since the conventional spherical lens is limited in simplification, an aspheric lens is needed. However, the manufacturing of the aspheric lens by use of the polishing method has a problem in mass production. For this reason, a popular tendency is to manufacture the aspheric lens by a press molding method.

A mold for press molding optical lens with high accuracy is necessary to fit the requirements as below: (1) the mold is strong enough and not deformed even at a high temperature, (2) the material of the mold surface does not react on the glass at a high temperature (or the glass does not adhere to the mold surface), (3) the press surface of the mold is hard enough not to be damaged by a scratch or the like, and (4) the mold is superior in resistance to heat shock.

A conventional mold for press molding optical lens has been reported to use silicon carbide (SiC), silicon nitride (Si₃N₄), titanium nitride (TiN), titanium carbide (TiC), vitreous carbon, tungsten carbide (WC), or nickel alloy. However SiC, Si₃N₄, and TiC have high hardness and it is very difficult to form these materials each into an aspheric shape with high accuracy. Moreover, these materials and WC are all to be sintered, and thus a third component is added as a sintering agent. Since the third component is easy to react on the glass, it makes it impossible to mold the optical lens with high accuracy. Also, the press molding using the aforesaid materials, vitreous carbon and TiN, is defective in that the press surface of the mold is oxidized and thus deteriorates unless the concentration of O₂ is controlled to be low. For the nickel alloy, the grain growth is generated under pressing at about 500° C., so that the press surface of the mold becomes rough. Hence, the nickel group alloy is not suitable for molding the glass optical element with high accuracy.

A composite mold for press molding optical lens is used for solving above problems. One typical composite mold comprises a base material and a press surface film formed on the base material. The press surface film is an Ir film, or a Ru film, or an alloy film comprising Ir and at least a member selected from the group consisting of Pt, Re, Os, Rh and Ru, or an alloy film comprising Ru and at least a member selected from the group consisting of Pt, Re, Os and Rh. Another kind of composite mold includes a base material and a surface film formed on the base material. The base material is high hardness alloy or metal ceramics. The surface film is a diamond like carbon. The lifetime of such kind of composite molds is not too long, because the surface film is easy to peel off or generate micro crack due to the action of the inner stress.

What is needed, therefore, is a mold for press molding optical lenses, in which the mold has high mechanical strength and good toughness. In addition, a method for manufacturing such kind of mold is also needed.

### SUMMARY

In one embodiment, a mold for press molding articles, such as optical lenses, includes a molding base and a surface film. The molding base is made by a sintered composite of carbon nano fibers and metal nano particles. The metal nano particles are selected a group consisting of platinum, platinum-iridium alloy, rhenium and rhenium-iridium alloy. The surface film is formed on the molding base by a sputtering deposition method or a chemical deposition method.

In another embodiment, a mold manufacturing method for the above described mold comprises the following steps:

mixing carbon nano fibers with metal nano particles so that they are all homogeneously distributed;

sintering the carbon nano fibers and the metal nano particles by a hot pressing method, thereby forming a molding base;

carving an optical pattern on a surface of the molding base; and

forming a film on the molding base.

Compared with prior arts, the present mold for press molding uses carbon nano fibers as a main structure and metal nano particles as additives to form a composite. Because carbon nano fibers have high mechanical strength and metal nano particles have good toughness, the prevent invention has higher mechanical strength and better toughness than conventional molds which are made by alloy or metal ceramics.

Other advantages and novel features will become more apparent from the following detailed description of preferred embodiments when taken in conjunction with the accompanying drawings.

### BRIEF DESCRIPTION OF THE DRAWINGS

Many aspects of the present invention can be better understood with reference to the following drawings. The components in the drawings are not necessarily to scale, the emphasis instead being placed upon clearly illustrating the principles of the present mold for press molding optical lens and method relating thereto.

FIG. 1 is a schematic, cross-sectional view of a mold for press molding optical lenses in accordance with a preferred embodiment of the present invention.

FIG. 2 is a flowchart of a method for manufacturing a mold, the mold being for press molding optical lenses.

Corresponding reference characters indicate corresponding parts throughout the several views. The exemplifications set out herein illustrate at least one preferred embodiment of the present invention, in one form, and such exemplifications are not to be construed as limiting the scope of the invention in any manner.

### DETAILED DESCRIPTION OF PREFERRED EMBODIMENTS

Reference will now be made to the drawings to describe embodiments of the present invention, in detail.

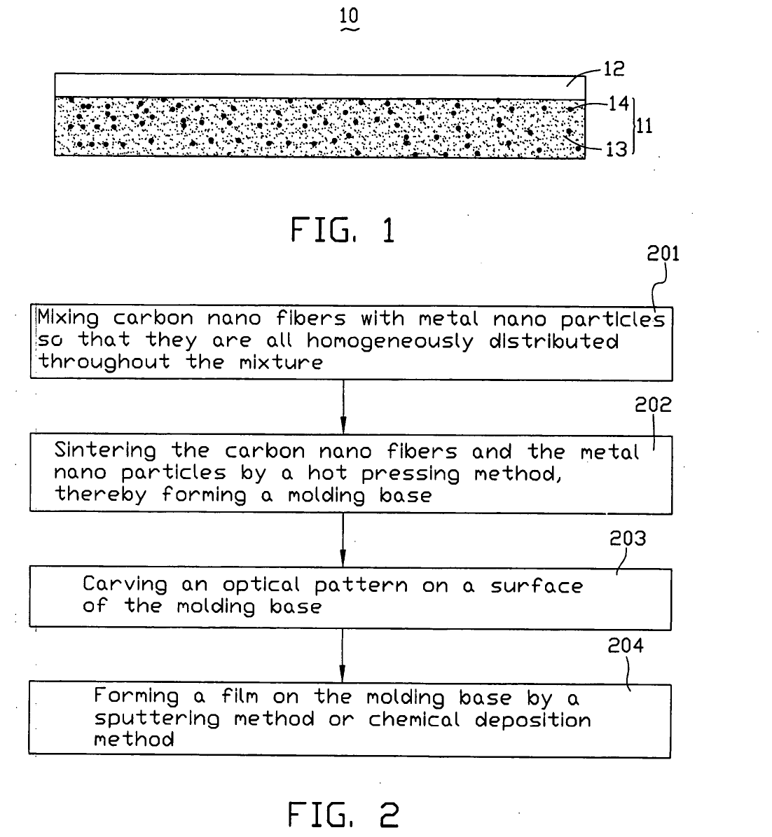

Referring to FIG. 1, this shows a mold in accordance with an exemplary embodiment of the present invention. The mold 10 is for press molding optical lenses, and comprises a molding base 11 and a surface film 12 formed on the molding base 11. The molding base 11 is a sintered composite of carbon nano fibers 13 and metal nano particles 14. The carbon nano fibers 13 are used as a main structure, and the metal nano particles 14 are used as additives. The metal nano particles 14 are preferably selected from Platinum, Platinum-Iridium alloy, Rhenium, and Rhenium-Iridium alloy. The carbon nano fibers 13 and the metal nano particles 14 are sintered by a hot pressing method to form the molding base 11. Then the surface film 12 is formed on the molding base 11 by a sputtering deposition or chemical vapor deposition method. A material of the surface film 12 is selected from Iridium, Rubidium, Platinum, and Rhenium.

Referring to FIG. 2, this is a flowchart of an exemplary embodiment of a method for manufacturing the mold 10. The method comprises the following steps:

mixing carbon nano fibers with metal nano particles so that they are all homogeneously distributed throughout the mixture (step 201);

sintering the carbon nano fibers and the metal nano particles by a hot pressing method, thereby forming a molding base (step 202);

carving an optical pattern on a surface of the molding base (step 203); and

forming a film on the molding base by a sputtering method or chemical deposition method (step 204).

Unlike in the prior art, the present embodiments utilize a combination of carbon nano fibers 13 and metal nano particles 14 as raw materials to form the molding base 11. The carbon nano fibers 13 have superior properties compared to steel and other metals. For example, the Young's modulus is about 10,000 GPa, the tensile modulus is more than 440 GPa, and the tensile strength is between 3500 and 5300 MPa. Because the carbon nano fibers 13 have high mechanical strength and the metal nano particles 14 have good toughness, the mold 10 has higher mechanical strength and better toughness than conventional alloy molds. Other advantages of the mold 10 are good fatigue resistance and dimensional stability.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A mold comprising:
a molding base comprising a sintered composite of carbon nano fibers and metal nano particles; and
a surface film formed on the molding base.

2. The mold as claimed in claim 1, wherein the carbon nano fibers are a main structure of the molding base, and the metal nano particles are additives to the main structure.

3. The mold as claimed in claim 2, wherein the metal nano particles are selected from the group consisting of platinum, platinum-iridium alloy, rhenium, and rhenium-iridium alloy.

4. The mold as claimed in claim 1, wherein the surface film is formed by a sputtering deposition method.

5. The mold as claimed in claim 1, wherein the surface film is formed by a chemical deposition method.

6. The mold as claimed in claim 1, wherein material of the surface film is selected from the group consisting of iridium, rubidium, platinum, and rhenium.

7. A mold manufacturing method comprising:
mixing carbon nano fibers with metal nano particles so that they are all homogeneously distributed;
sintering the carbon nano fibers and the metal nano particles by a hot pressing method, thereby forming a molding base;
carving an optical pattern on a surface of the molding base; and
forming a film on the molding base.

8. The method as claimed in claim 7, wherein the metal nano particles are selected from the group consisting of platinum, platinum-iridium alloy, rhenium, and rhenium-iridium alloy.

9. The method as claimed in claim 7, wherein the surface film is formed by a sputtering deposition method.

10. The method as claimed in claim 7, wherein the surface film is formed by a chemical deposition method.

11. The method as claimed in claim 7, wherein material of the surface film is selected from the group consisting of iridium, rubidium, platinum, and rhenium.
